(19) United States
(12) Patent Application Publication
(10) Pub. No.: US 2012/0130799 A1
(43) Pub. Date: May 24, 2012

(54) SYSTEM AND METHODOLOGY FOR DETERMINATION OF ADVERTISEMENT EFFECTIVENESS

(75) Inventors: Beauford W. Atwater, Bernardsville, NJ (US); Munir Cochinwala, Basking Ridge, NJ (US)

(73) Assignee: TELCORDIA TECHNOLOGIES, INC., Piscataway, NJ (US)

(21) Appl. No.: 13/112,272

(22) Filed: May 20, 2011

Related U.S. Application Data
(60) Provisional application No. 61/346,533, filed on May 20, 2010.

(51) Int. Cl. G06Q 30/02

(52) U.S. Cl. 705/14.41

(57) ABSTRACT

A system and method for determination of advertisement effectiveness is presented. The method can comprise obtaining records for domain elements, for each domain element, developing a model and populating the model based on the obtained records, for a record of a first domain element of the plurality of domain elements, searching a second domain element for another record matching the record of the one domain element, when a match is found, correlating a time stamp in the record with a time stamp in the other record and when correlated, determining a confidence level indicating the advertisement effectiveness. In one aspect, determining a confidence level further comprises searching a third domain element, obtaining a search result, and incorporating the search result in the confidence level. In one aspect, searching a third domain element further comprises performing a secondary search.

### CROSS REFERENCE TO RELATED APPLICATIONS

The present invention claims the benefit of U.S. provisional patent application 61/346,533 filed May 20, 2010, the entire contents and disclosure of which are incorporated herein by reference as if fully set forth herein.

### FIELD OF THE INVENTION

This invention relates generally to determining advertisement effectiveness.

### BACKGROUND OF THE INVENTION

Merchants need to determine the effectiveness of advertisements (“ads”), product reviews, and/or sales campaigns. In particular, they would like to know if a particular ad resulted in a customer making a purchase. Ideally, merchants would like to know what user behavior(s), such as viewing an ad, viewing/participating in a sales campaign, and/or browsing customer reviews, led to the purchase.

In general, if a user sees an ad while browsing on the internet, clicks the ad and then makes a purchase from the website connected to the ad, the merchant knows that the ad resulted in a purchase. Tracking user behavior leading to a purchase where all actions are contained within a session or within a single provider's environment, such as Amazon, is relatively easy. The problem is that a user may view an ad on one day and then buy the item a week later. Compounding the problem is that the user may use different mechanisms for the ad and the purchase. For example, the user may view the ad on the internet while browsing/searching but may purchase the item by calling a particular telephone number, such as an 800 number, or by going to a store and buying it in person. A user typically also looks at product reviews and/or at sales at local stores or on the internet or both.

User purchase actions are not based on ads only. In general, a user browses product reviews, gets feedbacks from his or her social networks about a product and browses current sales whether they are online or in the local area shops. In these non-session based purchasing scenarios, the merchant does not really know whether the user even viewed the ad before purchasing or whether the purchase was just a spur of the moment event, or whether it was made based on looking at reviews or on a sale in a local store. Essentially, user behavior spans multiple sessions across multiple days. Users typically will explore more than simply a merchant's ad, or site.

An entire industry has been built around advertisement effectiveness. Virtually all of the techniques used are inferential. For example, a company might say that an ad campaign was successful because it realized an increase in revenue during the campaign. While this itself may be good inferential evidence, direct causality is not established. Sophisticated techniques can be used to track behavior in different demographics. Most techniques measure ‘eyeballs’, defined as number of people who viewed the ad, which could be the result of a search operation with the ads as by-lines or to the side. Another mechanism commonly used is measuring ‘clicks’ which actually track number of people who clicked on the ad. In all cases, a purchase related to user behavior is not detected unless, as previously mentioned, user interaction is within a single session or within a single provider.

However, there is no technique or vendor that provides direct correlation between ad viewing/display or general user behavior/evaluation before a purchase. There is also no technique which provides correlation about a user browsing and reviewing product ratings before purchasing.

There have been proposed procedures that artificially try to create sessions by providing a user specific internet address, e.g., URL, or telephone number for a specific item. However, there is a need for a technique that can correlate data regarding user behavior across the web including ad viewing, searching and viewing product ratings and combining this data with actual purchases. Making the problem more complex, in the general case, this information is in diverse formats across a multitude of providers.

### SUMMARY OF THE INVENTION

The inventive solution requires combining the results of the derivation of the data models to facilitate matching across the different data sources and models. Derivation of the data model is made possible by restriction of the domain such as financial records, merchant catalog or SMS format. The models in these well-understood domains can be readily developed. The derived data models, which are obtained from the data itself, then provide for refined searches of the data based on information inferred from the data and the models. Accordingly, the novel procedure directly links user behavior (including viewing ads, exploring product ratings, etc.) with purchases outside the internet.

A system for determination of advertisement effectiveness can comprise a CPU and modules as follows. For each domain element, the system can comprise a first module operable to develop a model and populate the model based on the obtained records, and for a record of a first domain element of the plurality of domain elements, a second module operable to search a second domain element for another record matching the record of the one domain element and when a match is found, correlate a time stamp in the record with a time stamp in the other record and when correlated, determine a confidence level indicating the advertisement effectiveness.

In one aspect, the second module is further operable to search a third domain element, obtain a search result, and incorporate the search result in the confidence level. In one aspect, the second module is further operable to perform a secondary search.

A method for determination of advertisement effectiveness can comprise obtaining records for a plurality of domain elements, for each domain element, developing a model and populating the model based on the obtained records, for a record of a first domain element of the plurality of domain elements, searching a second domain element for an other record matching the record of the one domain element, when a match is found, correlating a time stamp in the record with a time stamp in the other record and when correlated, determining a confidence level indicating the advertisement effectiveness.

In one aspect, determining a confidence level further comprises searching a third domain element, obtaining a search result, and incorporating the search result in the confidence level. In one aspect, searching a third domain element further comprises performing a secondary search.

A computer readable storage medium storing a program of instructions executable by a machine to perform one or more methods described herein also may be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a flow diagram of the inventive method.

FIG. 2 shows an example of one embodiment of the inventive system.

FIG. 3 shows exemplary records in accordance with the example shown in FIG. 2.

### DETAILED DISCLOSURE

A system and method for determining advertising effectiveness is presented. The inventive process derives from knowledge of data models, of linking diverse data models across multiple data sources and of abstracting data into general classes.

The innovative technique provides an overall system and methodology to link user behavior to purchases as well as to solve two specific issues: derivation of data models across arbitrary logs so that parsing and correlation are possible, and matching across diverse representations of the same item.

Product purchasers typically make purchasing decisions that are chronicled in several diverse collections of data, e.g., logs, by a diverse collection of vendors. Such data collections can include financial information, such as credit card records, telephone information such as calls made, and internet information, such as web sites viewed, etc. To determine the effectiveness of an ad, data from these logs must be obtained and combined. However, the records to be obtained from searching the logs can have differing numbers of fields and different delimiters, and which fields have the required data must be determined. Even within one class of records, such as financial records from vendors such as Visa®, MasterCard®, American Express®, Paypal®, the record format can differ. Likewise, web server logs have a standard structure but are nearly endless in formatting options. By contrast, telephone records, including those from mobile providers, typically have similar formats, even among different vendors.

The problem of diverse collections of data or logs can be illustrated as follows.

Data set 1:
Record 1: Fields(1-n)
Record a: Fields(1-n)

Data set 2:
Record 1: Fields(1-m)
Record b: Fields(1-m)

Data set 3:
Record 1: Fields(1-k)
Record 2: Fields(1-j)
Record c: Fields(1-i)

This shows differing numbers of fields and different delimiters. For example, Data sell has two record formats, Record 1 and Record a, each with fields 1-n, and Data set 2 has two record formats, Record 1 and Record b, each with fields 1-m. Data set 3 has three record formats, Record 1, Record 2 and Record c, each with a different number of fields; Record 1 has k fields, Record 2 has j fields and Record c has i fields. The desired fields must be obtained from the appropriate records.

In the inventive process, given a domain and entity definition, specific models can be generated from the data. The generation of these models can be performed on a computer having a CPU. This works well in a specific domain where entities can be identified. For example, given a financial model that has date, amount, and vendor, specific models can be developed for each vendor, such as Visa®, Paypal®, and American Express®, based on the data itself. One embodiment focuses on the domain of web search logs, financial transaction logs, and telephone logs from land-line and mobile providers. Another embodiment can also include social networks in the domain.

Once specific models (financial, phone, web, etc.) are generated, the data is extracted and populated so that it is possible to search for specific persons, transactions, dates, numbers, etc. The data among the models can then be searched to link purchases to web browsing and phone calls. The result will be a link with a confidence probability.

The search results can be further refined using secondary and tertiary searching, and examined, providing the resulting link with higher levels of confidence.

Accordingly, the inventive technique requires combining the results of the derivation of the data models to facilitate matching across the different data sources and models. Derivation of the data model is made possible by restriction of the domain to, for example, financial records, vendor or merchant catalogs and/or SMS formatted-data. Matching across diverse representations also includes using secondary information such as directories for looking up merchants or users based on phone numbers.

Each vendor or ‘log provider’ would have its own format and implicit data model for its log. Derivation of a data model for data of unknown structure or origin is not a solved problem. The novel solution presented here defines a domain such as financial information for a credit card, a short message record or records for web browsing, and further defines the overall model that can be applied to different vendors or providers who have similar information in different structures and names.

For example, web logs from Yahoo® or Google® may be structured or formatted differently but each will have the user action, URL, etc. In accordance with the present invention, model derivation can also use fuzzy matching across the fields in the model to handle different spellings, acronyms, etc.

The inventive approach requires fuzzy matching as well as secondary data sources. Fuzzy matching requires, for example, matching “BBuy” to “BestBuy”. This can be done by using edit distances, along with a list of appropriate merchants and products of interest. The list of products per merchant can be obtained from the merchant catalog. This can be a semi-automated operation.

Secondary data sources and matching are not limited to matching based on fuzzy matches. Additional secondary information, such as directory listings, can be used to correlate items such as phone numbers to merchants or people. Proper correlation requires identifying the appropriate user or merchant and secondary data sources may have to be consulted in order to correlate appropriately.

As discussed above, the invention provides mechanisms to correlate logs across diverse sources. Thus, access to logs of user behavior such as server logs from web searches, mobile phone usage, and credit card purchases is required. Such access necessitates user authorization and the invention includes a clearinghouse that provides a mechanism for users to opt-in so that the clearinghouse can have access to the logs. The clearinghouse uses the user authorization to get the logs from the relevant merchants. The clearinghouse system also provides a mechanism to configure and link new data sources.

Note that the clearinghouse needs a mechanism to retrieve logs from the appropriate vendors whose logs are relevant, such as search engines, ISPs, credit cards and the merchants' brick-and-mortar stores. It is not required that this operation be performed online but an online mechanism to get merchant logs would streamline the operation. Furthermore, each merchant may send a bulk log to the clearinghouse with all the users for which authorization is provided and the clearinghouse can provide appropriate partitioning. The clearinghouse can be located on a server, on the internet, a virtual computer system, or in any location known to those skilled in the art.

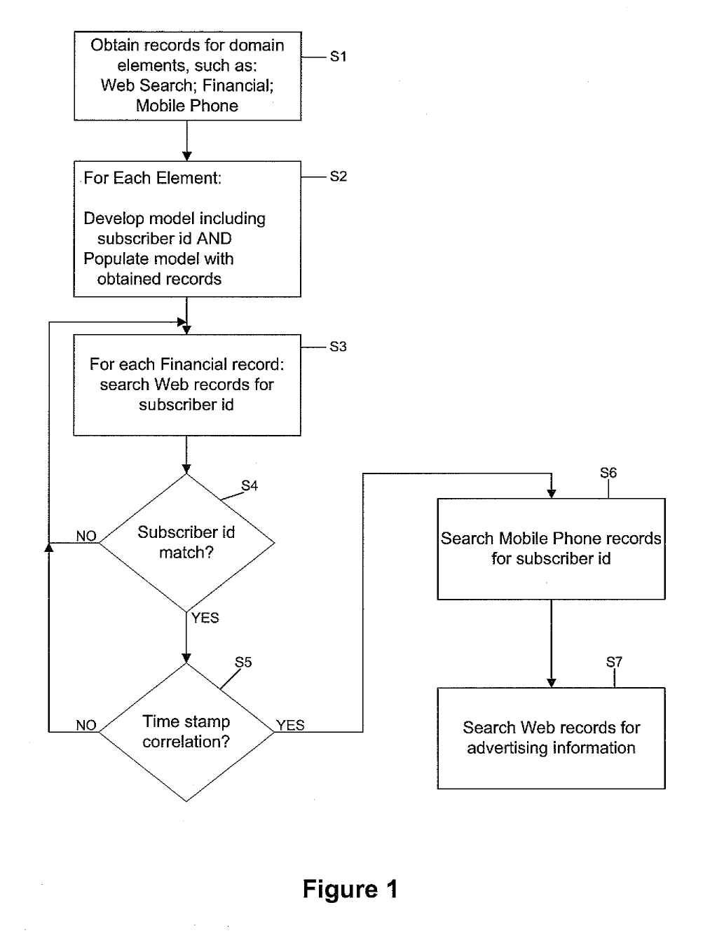

A flow diagram of the inventive method is shown in FIG. 1. In step S1, records are obtained for domain elements. In one embodiment, these elements are Web Search records, Financial records and Mobile Phone records. However, the invention is not limited to these domain elements. For example, other domain elements can be Merchant records, Social Network records, etc.

In step S2, for each element, a model is developed based on the records obtained in step S1 and the model is populated with these obtained records. The model includes, among other things, a subscriber identifier, and a time stamp or indicator of the time the action noted in the record was performed. In step S3, for each Financial record, e.g., each record indicating a purchase, the Web Search records are searched for the subscriber identifier of this Financial record. Any searching technique known to those skilled in the art can be used. When the current record does not match (S4=NO), the search continues with the next record at step S3.

When a match is found (S4=YES), the time stamp in the Web Search record is compared to the time stamp in the Financial record in step S5. If the time stamps correlate the records (S5=YES), then the Mobile Phone records are searched in step S6. Optionally, a secondary search can be performed to obtain more details regarding the Web Search information and the information from this secondary search can be used to augment the search of the Mobile Phone records. Upon completion of step S6, the Web Search records are searched and examination of referring web sites is performed to obtain any link to on-line advertisements regarding the subscriber identifier and its advertised product. If a link is found, in step S8 a post condition is determined, such as that the financial transaction is linked to a web search with a confidence level of 100%.

If the time stamps do not correlate the records (S5=NO), the process resumes at step S3 with the next Web Search record.

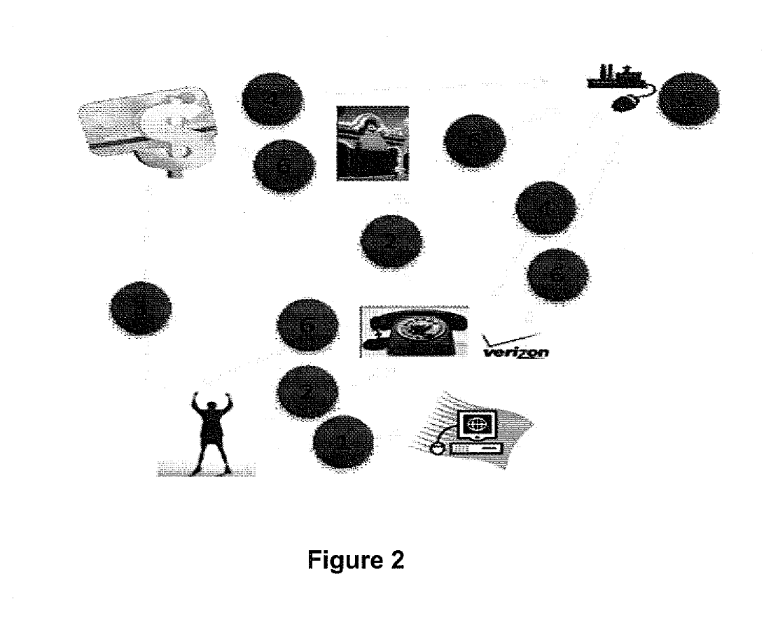

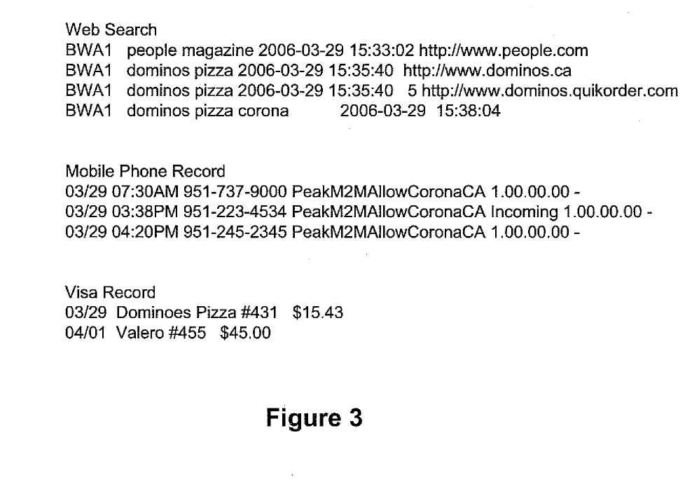

An example of an embodiment of the inventive system and method is presented and illustrated in FIG. 2. The example assumes that the user has opted-in, merchant logs are available and the data model has been created and the data structured and defined. Secondary sources are also available. FIG. 3 shows sample records associated with this example.

In this example, the following preconditions are assumed: Clearinghouse has obtained records from Visa® (credit card—“Visa Record”) and Verizon® (mobile provider “Mobile Phone Record”) and Google® (search provider—“Web Search”). In step 1, Web search data is used to develop a specific model for web searching. Data is then populated into the model. In step 2, the process is repeated for mobile and transaction, e.g., credit card, records. In step 3, for each financial transaction, web records are searched. A link is found for Domino's. The time stamps of the financial and web search records are compared for confidence level in step 4. A secondary search is done for Domino's phone numbers in step 5. In step 6, phone records are searched, returning a link to a Domino's in Corona, Calif. In step 7, a search of the web log and examination of referring web sites reveals the link to a Domino's ad on the People® magazine website. Hence a post condition is determined that the financial transaction is linked to a web search with a confidence level of 100%.

Note that this example employs time stamp comparisons to establish a confidence level for the correlation. Note also that, in step 5, a secondary search is done to correlate a phone number with the Domino's pizza in Corona.

The next example illustrates the transactions among the partners or participants in a prototypical situation. In this example, the following preconditions are assumed: Clearinghouse has obtained records from Visa® (credit card) and Verizon® (mobile provider) and Google® (search provider). In step 1, a user searches for a restaurant on the Web, and finds one of interest; this restaurant is a subscriber to the inventive system. Optionally, in step 2, the user calls the restaurant, using his Verizon® mobile phone, to determine its hours. In step 3, the user pays for his or her meal with a Visa® card. Visa® and Verizon® and Google® send transactions to Clearinghouse in step 4. In step 5, Clearinghouse correlates the web and phone transactions with the financial transaction. In step 6, the restaurant pays Clearinghouse and Visa®. Clearinghouse pays subscriber and Verizon®. Alternatively, Clearinghouse pays Verizon® and Verizon® pays subscriber. A post condition is that all participants, Visa®, Verizon®, Clearinghouse and the subscriber are paid.

The result of the novel technology is that individual user behavior can be tracked to the purchase. When aggregated across a large user pool, businesses can understand what behavior led to a purchase of their product in a granularity not capable with current inferential analyses. They will have a much better understanding of the marketing capabilities. They will become much more efficient in their use of marketing and advertising budgets.

With this invention, merchants can now get specific information on what persuaded a buyer to purchase a good whether it was an ad, product ratings or simply brand name. Thus, merchants can now spend their advertisement funds wisely and in a targeted manner. In addition, mobile providers, such as Verizon® and AT&T®, can now leverage their broadband capability into collecting user behavior information.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc. The system also may be implemented on a virtual computer system, colloquially known as a cloud.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for determination of advertisement effectiveness, comprising steps of
obtaining records for a plurality of domain elements;
for each domain element, developing a model and populating the model based on the obtained records;
for a record of a first domain element of the plurality of domain elements:
searching a second domain element for an other record matching the record of the one domain element;
when a match is found, correlating a time stamp in the record with a time stamp in the other record and when correlated, determining a confidence level indicating the advertisement effectiveness.

2. The method according to claim 1, the step of determining further comprising steps of:
searching a third domain element and obtaining a search result; and
incorporating the search result in the confidence level.

3. The method according to claim 1, the step of searching a third domain element further comprises performing a secondary search.

4. A system for determination of advertisement effectiveness, comprising:
a CPU;
for each domain element, a module operable to develop a model and populate the model based on the obtained records;
for a record of a first domain element of the plurality of domain elements, a module operable to search a second domain element for an other record matching the record of the one domain element and when a match is found, correlate a time stamp in the record with a time stamp in the other record and when correlated, determine a confidence level indicating the advertisement effectiveness.

5. The system according to claim 4, wherein the module is further operable to search a third domain element, obtain a search result, and incorporate the search result in the confidence level.

6. The system according to claim 5, wherein the module is further operable to perform a secondary search.

7. A computer readable storage medium storing a program of instructions executable by a machine to perform a method for determination of advertisement effectiveness, comprising:
obtaining records for a plurality of domain elements;
for each domain element, developing a model and populating the model based on the obtained records;
for a record of a first domain element of the plurality of domain elements:
searching a second domain element for an other record matching the record of the one domain element;
when a match is found, correlating a time stamp in the record with a time stamp in the other record and when correlated, determining a confidence level indicating the advertisement effectiveness.

8. The computer readable storage medium according to claim 7, wherein determining a confidence level further comprises:
searching a third domain element and obtaining a search result; and
incorporating the search result in the confidence level.

9. The computer readable storage medium according to claim 8, wherein searching a third domain element further comprises performing a secondary search.
